(19) United States
(12) Patent Application Publication
(10) Pub. No.: US 2006/0199072 A1
(43) Pub. Date: Sep. 7, 2006

(54) Battery operation device with battery pack release mechanism

(75) Inventors: Tat Nin Lui, Hong Kong (HK); Scott Sze Kok Fong, Aberdeen (HK); Zu Sheng Tan, Shen Zhen (CN)

Correspondence Address: LEYDIG VOIT & MAYER, LTD, 700 THIRTEENTH ST. NW, SUITE 300, WASHINGTON, DC, 20005-3960, US

(73) Assignee: Perpetual Green Ltd., Causeway Bay (HK)

(21) Appl. No.: 11/070,370

(22) Filed: Mar. 3, 2005

(51) Int. Cl. H01M 2/10

(52) U.S. Cl. 429/97

(57) ABSTRACT

A battery operated device includes a body housing an electric motor, a battery pack slidably secured to the body for powering the electric motor and including a shunting surface, a latching surfaces and a release member. A release button is mounted on the body and has a first surface engageable with the release member to effect movement of the release member away from the latching surface upon depression of the release button, and a second surface engageable with the shunting member upon depression of the release button to effect movement of the battery pack in a release direction.

The present invention relates to a battery operated device having a detachable battery pack.

### BACKGROUND OF THE INVENTION

More particularly, although not exclusively, the invention relates to a power tool having a rechargeable battery pack that is slidably secured to the power tool and wherein the power tool comprises a battery pack release mechanism that both releases the battery pack from a locked position and pushes the battery pack in a release direction.

Power tools having removable rechargeable battery packs are known to have a depressible release button, which when depressed, unlatches the battery pack from the power tool body. The battery pack must then be drawn away from the power tool body. In most cases, the battery pack must be pulled away with some force so as to overcome a retaining resistance. Also, the user might not know in which direction to pull the battery pack away from the tool body.

### OBJECTS OF THE INVENTION

It is an object of the present invention to overcome or substantially ameliorate at least one of the above disadvantages and/or more generally to provide an improved battery operated device having a battery pack release mechanism.

### SUMMARY OF THE INVENTION

According to the invention, there is provided a battery operated device comprising:
a body housing an electric element;
a battery pack slidably engageable with the body for powering the electric element and including a shunting surface, a latching surface and a release member; and
a release button mounted to the body, the release button having a first surface engageable with the release member to effect movement thereof releasing the latching surface upon depression of the release button, and a second surface engageable with the shunting surface upon depression of the release button to effect movement of the battery pack in a release direction.

Preferably, each of the first and second surfaces comprises a ramp.

More preferably, the ramps are offset from one another by substantially 90 degrees.

In a preferred embodiment, the release member comprises a knob from which the latching surface extends laterally for engagement with a latch of the body.

More preferably, the knob has extending therefrom a spring to bias the release member into a locked position in which the release member bears against the release button to force the release button into a rest position.

It is preferred that the shunting surface, the latching surface, the release member and the release button comprise a first set of components, and wherein the battery operated device comprises a second set of identical components in mirror image disposition with respect thereto.

It is further preferred that the release buttons of the two sets of components are aligned with each other for depression in directly opposite directions.

As an example, the battery operated device is a power tool, in which the electric element comprises an electric motor.

### BRIEF DESCRIPTION OF DRAWINGS

The invention will now be more particularly described, by way of example only, with reference to the accompanying drawings, in which:

FIG. 1 is a side view of an embodiment of a battery operated device in accordance with the invention, said device being a power tool with its battery pack attached;

FIG. 2 is a side view of a power tool of FIG. 1, with its battery pack pushed slightly during release;

FIG. 3 is an internal plan view showing a battery pack release mechanism of the power tool of FIGS. 1 and 2;

FIG. 4 is a cross-sectional end view of the power tool's battery pack of FIG. 1, taken along line IV-IV;

FIG. 5 is a cross-sectional side view of the battery pack locked to the power tool body of FIG. 1, taken alone line V-V of FIG. 4;

FIG. 6 is a cross-sectional side view of the battery pack unlocked from the power tool body of FIG. 2, taken along line VI-VI of FIG. 8;

FIG. 7 is an internal plan view showing the battery pack release mechanism of FIG. 2; and

FIG. 8 is a cross-sectional end view of the battery pack of FIG. 2 in an unlocked configuration, taken along line VIII-VIII.

### DETAILED DESCRIPTION OF PREFERRED EMBODIMENT

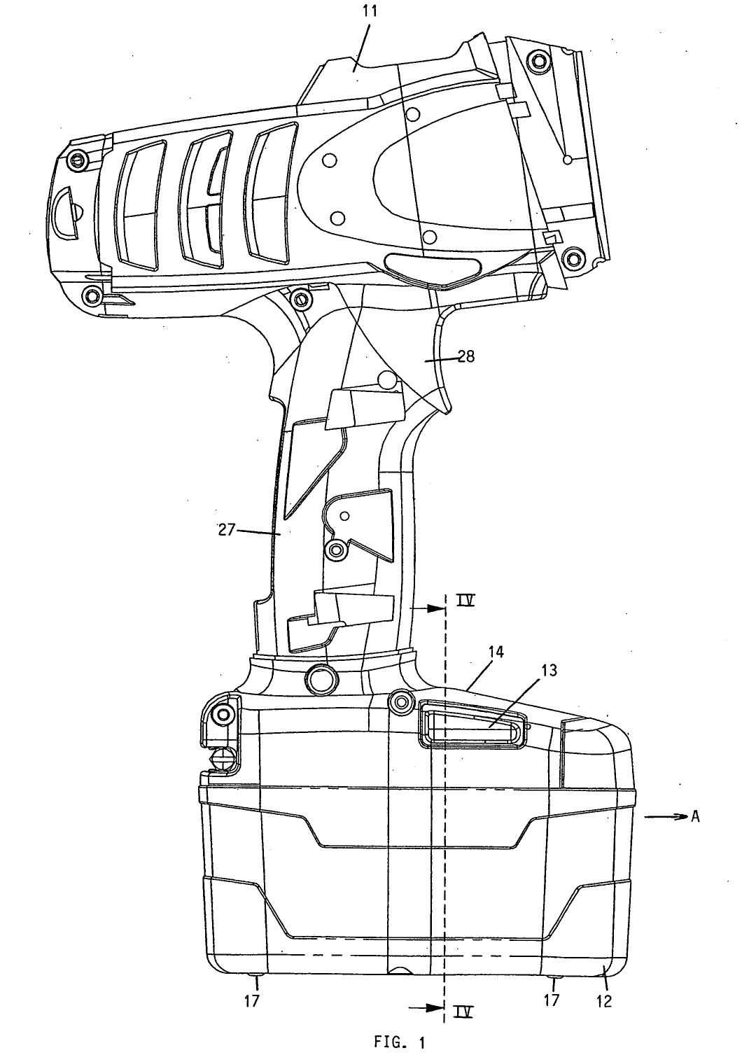

Referring to the drawings, there is shown a battery operated device embodying the invention, in the form of a power tool having a body 11, a handle 27 and an activation trigger 28. An electric motor 10 would be provided within the tool body 11 for driving a drill chuck for example. At the base of the handle 27, there is provided a cowling 14 on which there is provided a pair of laterally opposed release pushbuttons 13. A battery pack 12 is slidably connected to the cowling 14 and comprises a number of feet 17 by which the battery pack can be used as a base to support the power tool on a flat surface. Electrical contacts (not shown are provided under the cowling 14 and upon the battery pack 12 such that in the attached position as depicted in FIG. 1, there is an electrical circuit formed between the battery pack 12 and the tool casing 11.

Each pushbutton 13 has extending inwardly thereof a first pusher 15 having an angled ramp surface 22 at its inner-most end. Each pushbutton 13 also has extending inwardly thereof a second pusher 18 having an angled ramp surface 23 at its inner-most end. Ramp surfaces 22 and 23 are offset from one another by 90 degrees.

Fixed to the battery pack 12 is a shunting member 16 having a pair of laterally opposed ramp surfaces (shunting surface) 21 against which the respective ramp surfaces 22 bear upon depression of the pushbuttons 13 toward one another. Upon depression of the pushbuttons 13, the interaction of ramp surfaces 21 and 22 causes movement of the shunting member 16 and hence the battery pack 12 with which it is connected in the direction indicated by arrow A in FIGS. 1 to 3.

Slidably mounted within the battery pack 12 below the cowling 14 is a pair of release knobs 19. The release knobs 19 are adapted to move up and down against the resilience of a respective coil spring 20. Each release knob 19 has a ramp surface 24 at its upper-most end engaging with the ramp surface 23 of the respective second pusher 18. As the pushbuttons 13 are pushed toward one another, the release knobs 19 are caused to move downward against the springs 20.

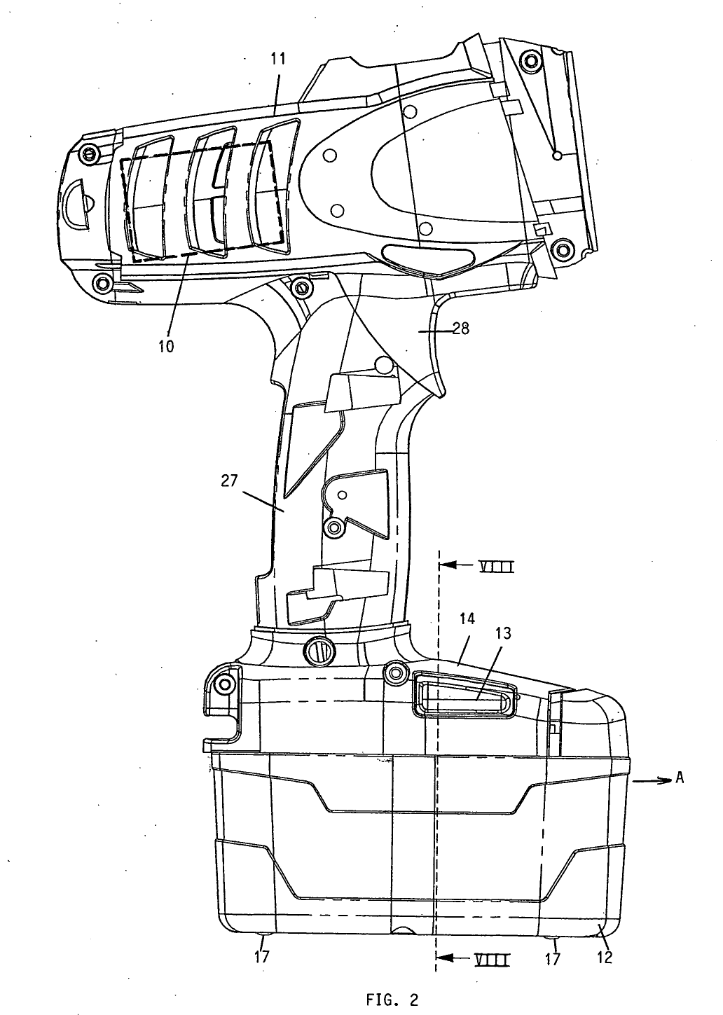

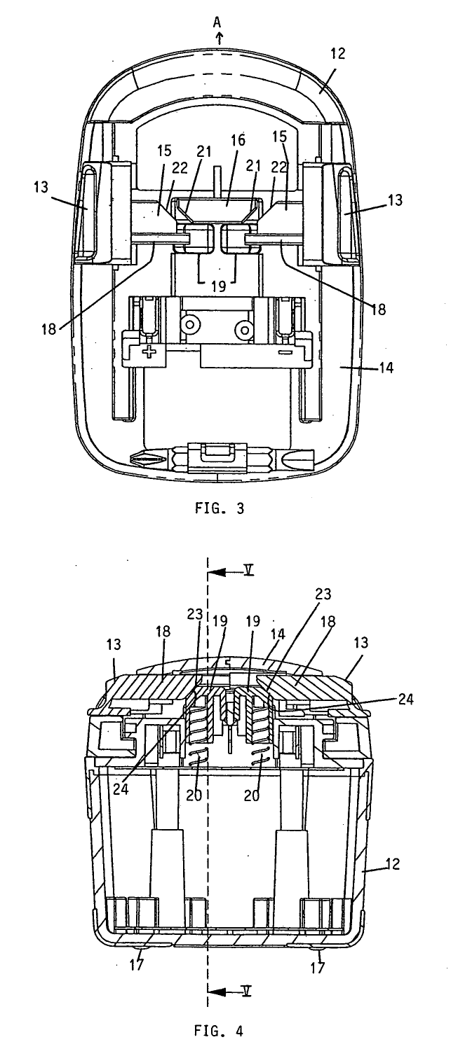

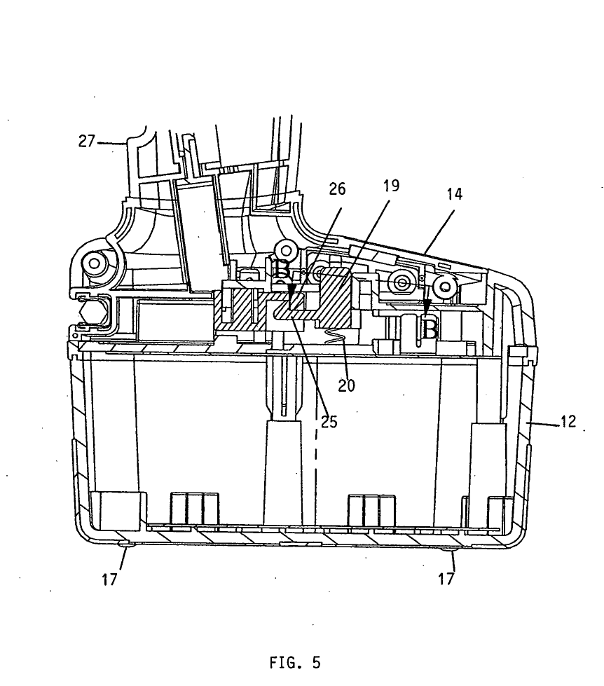

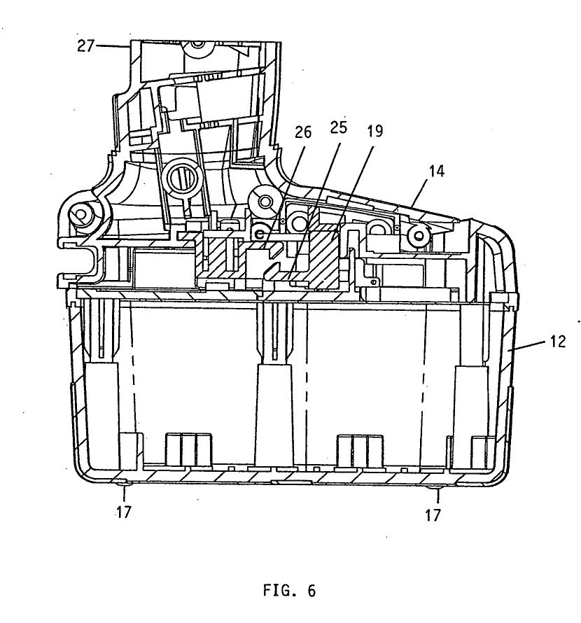

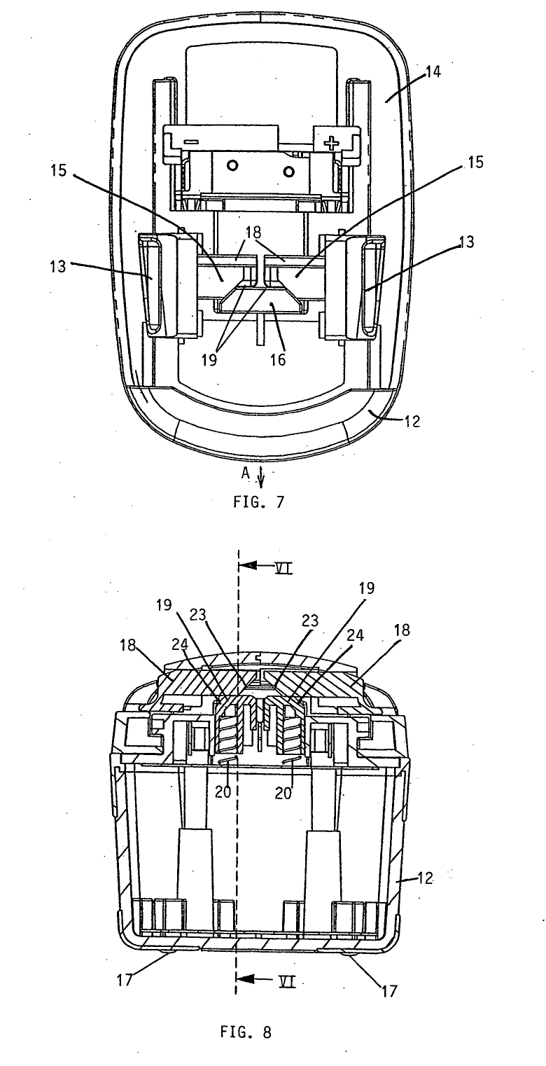

Extending laterally from each release knob 19 is a latching member 25 which extends under a latch 26 that is affixed to or formed integrally with the tool body 11. As the release knobs 19 move downwardly, the latching members 25 move downwardly away from the latches 26 to enable the interaction of the first pusher 15 with the shunting member 16 to push the battery pack 12 slightly forward along its mounting track to the position indicated in FIG. 2. A user having depressed the release buttons 13 can then witness movement of the battery pack 12 in the direction indicated by arrows A can then manually withdraw the battery pack 12 by continuing to pull it in the same direction.

Upon release of hand pressure from the pushbuttons 13, the coil springs 20 push the release knobs 19 upwardly so that the ramp surfaces 23 and 24 interact to cause movement of the pushbuttons 13 outwardly to their rest positions. For ease of operation, the left and right pushbuttons 13 are aligned with each other transversely with respect to the battery pack 12 for simultaneous depression in directly opposite directions.

Attaching a fresh or fully recharged battery pack 12 to the tool body 11 is a simple matter of sliding the battery pack 12 along its track until the latching members 25 hook under the latches 26.

The described power tool may be an electric hand drill for example. It is envisaged that any other types of battery operated devices may employ the invention, such as a floodlight.

The invention has been given by way of example only, and various modification of and/or alterations to the described embodiment may be made by persons skilled in the art without departing from the scope of the invention as specified in the appended claims.

1. A battery operated device comprising:
a body housing an electric element;
a battery pack slidably engageable with the body for powering the electric element and including a shunting surface, a latching surfaces and a release member; and
a release button mounted on the body, the release button having a first surface engageable with the release member to effect movement of the release member releasing the latching surface upon depression of the release button, and a second surface engageable with the shunting surface upon depression of the release button to effect movement of the battery pack in a release direction.

2. The battery operated device as claimed in claim 1, wherein each of the first and second surfaces comprises a ramp.

3. The battery operated device as claimed in claim 2, wherein the ramps are offset from one another by substantially 90 degrees.

4. The battery operated device as claimed in claim 1, wherein the release member comprises a knob from which the latching surface extends laterally for engagement with a latch of the body.

5. The battery operated device as claimed in claim 4, wherein the knob has extending therefrom a spring to bias the release member into a locked position in which the release member bears against the release button to force the release button into a rest position.

6. The battery operated device as claimed in claim 1, wherein the shunting surface, the latching surface, the release member and the release button comprise a first set of components, and wherein the battery operated device comprises a second set of identical components in mirror image disposition with respect to the first set of components.

7. The battery operated device as claimed in claim 6, wherein the release buttons of the first and second sets of components are aligned with each other for depression in directly opposite directions.

8. The battery operated device as claimed in claim 1, being a power tool, wherein the electric element comprises an electric motor.
